(19) United States
(12) Patent Application Publication
(10) Pub. No.: US 2013/0091024 A1
(43) Pub. Date: Apr. 11, 2013

(54) DIGITAL BILLBOARD ADVERTISING SYSTEM AND METHOD

(71) Applicants: David Etherington, New York, NY (US); Jens Orrillo, New York, NY (US)

(72) Inventors: David Etherington, New York, NY (US); Jens Orrillo, New York, NY (US)

(21) Appl. No.: 13/267,328

(22) Filed: Oct. 6, 2011

(51) Int. Cl. G06Q 30/02

(52) U.S. Cl. 705/14.72

(57) ABSTRACT

A system and method allows consumers to post media on a digital billboard. The present invention allows consumers to visit a website, choose an available date and time, purchase a span of time (typically from 15 seconds to 1 minute), and upload media to be displayed on the digital billboard. The present invention reserves and schedules space and guarantees that the media will be displayed at the selected time. The present invention may be designed for individuals and, during the purchased span of time, the consumer's media will dominate the screen entirely and not compete with a sponsor brand. The present invention may stream a live feed of the digital billboard on the internet for the consumer (or others) to view. The present invention may also allow people to select various web platforms (such as Facebook, Twitter and the like) on which their experience is shared.

### BACKGROUND OF THE INVENTION

The present invention relates to advertising systems and methods and, more particularly, to a web and mobile-based service allowing individuals to upload media to a digital billboard.

Currently, customers have no way of knowing exactly when or if they can secure their media on a digital billboard. There is currently no way for consumers to have affordable access to a publicly seen digital billboard or reserve the time and date they want.

As can be seen, there is a need for a system and method for allowing consumers to secure a time and date to display media on a digital billboard.

### SUMMARY OF THE INVENTION

In one aspect of the present invention, a computer-readable medium containing programmable code for implementing a system for displaying media on a digital billboard comprises a code sequence adapted to receive media from a user; a code sequence adapted to create a media presentation to fit on a billboard for a predetermined time interval; a code sequence adapted to receive a selected date and time for displaying the media presentation on the billboard; a code sequence adapted to transmit the media presentation to the billboard at the selected time and date; and a code sequence adapted to transmit the media presentation to other media platforms as selected by the user.

In another aspect of the present invention, a method for displaying a media presentation on a billboard comprises receiving media from a user; creating the media presentation to fit on the billboard for a predetermined time interval; receiving a selected date and time for displaying the media presentation on the billboard; transmitting the media presentation to the billboard at the selected time and date; and transmitting the media presentation to other media platforms as selected by the user.

These and other features, aspects and advantages of the present invention will become better understood with reference to the following drawings, description and claims.

### BRIEF DESCRIPTION OF THE DRAWINGS

FIG. 1 is a flowchart describing the system and method according to embodiments of the present invention;

FIG. 2 is a continuation of the flowchart of FIG. 1;

FIG. 3 is a continuation of the flowchart of FIG. 2;

FIG. 4 is a continuation of the flowchart of FIG. 3;

FIG. 5 is a continuation of the flowchart of FIG. 2; and

FIG. 6 is a continuation of the flowchart of FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a system and method for allowing consumers to post media on a digital billboard. The present invention allows consumers to visit a website, choose an available date and time, purchase a span of time (typically from 15 seconds to 1 minute), and upload media to be displayed on the digital billboard. The present invention reserves and schedules space and guarantees that the media will be displayed at the selected time. The present invention may be designed for individuals and, during the purchased span of time, the consumer's media will dominate the screen entirely and not compete with a sponsor brand. The present invention may stream a live feed of the digital billboard on the internet for the consumer (or others) to view. The present invention may also allow people to select various web platforms (such as Facebook and the like) on which their experience is shared.

The present invention may include a plurality of custom-built design templates (for video, photos, text, or a combination thereof) that allow for consumers to use their span of time (i.e., 15 seconds) for the best effect. The templates may be available to customers on a design website. The present invention may further allow users to select a freeze-frame image of the billboard display to appear on personalized merchandise, such as t-shirts, mugs, or the like.

The present invention may include a computer-readable medium containing programmable code for implementing a system and methods described below. The computer-readable medium may be contained on a computer. The computer may be connected to the internet to permit users to access various functionality of the computer.

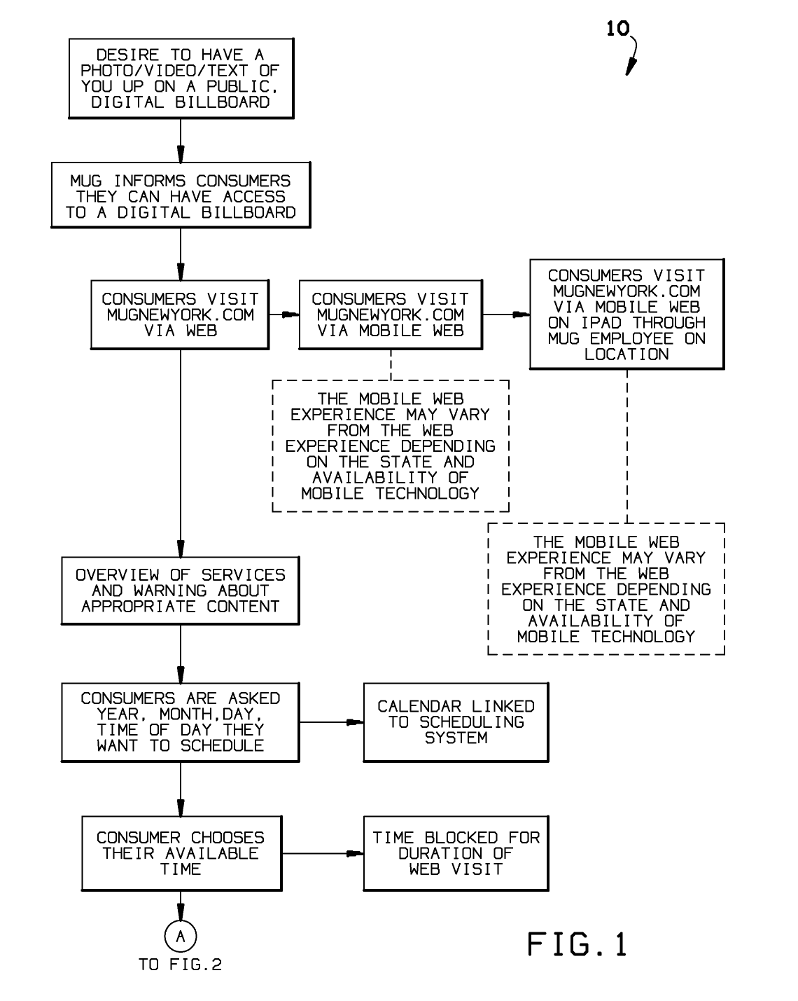

Referring to FIGS. 1 through 6, a desire to have a photo/video/text up on a public billboard may describe the urge of consumers to want to be famous, be part of the DNA of New York City, for example, visit times Square, and share content with friends across multiple platforms. The system (referred to as MUG in FIGS. 1-6) may inform the consumer that they can have access to a digital billboard. This informing step may include various advertising and public relations campaigns. Interested consumers may visit an internet site via a computer having access to the internet, via mobile web, via a smart phone or similar device (such as an I-pad®) having a particular application loaded thereupon, or via a mobile web through a MUG employee on location.

Once the consumer accesses the system, the consumer may receive an overview of the services available and warnings of appropriate content. This step may include showing the consumer some prior consumer experiences, showing the consumer a live feed of the billboard, directing the consumer to frequently asked questions, and the like.

Once the consumer decides to proceed, they may choose a time and date for their media to be displayed. Typically the time is broken up into 15 second spots, although other time spans may be used. Once a time slot is chosen, that spot may be held for the entire session to ensure no other users take the same time slot.

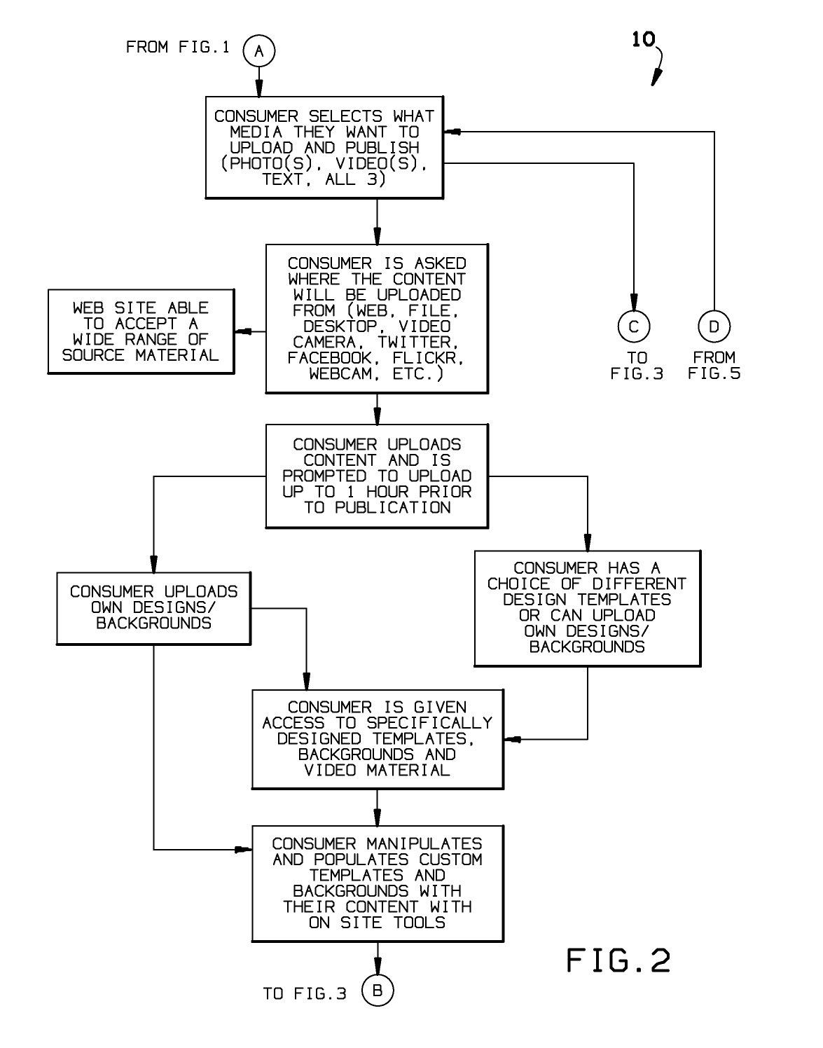

Referring to FIG. 2, the consumer may select what media to upload and publish. The media may be, for example, photos, videos, text, or a combination thereof. The consumer may be required to upload content, or may be allowed to edit content, up to a predetermined time period prior to publication. For example, the consumer may be able to edit and/or add content up to 1 hour prior to publication. The software may present the user a number of backgrounds, templates, designs and the like. Alternatively, the user may use their own design.

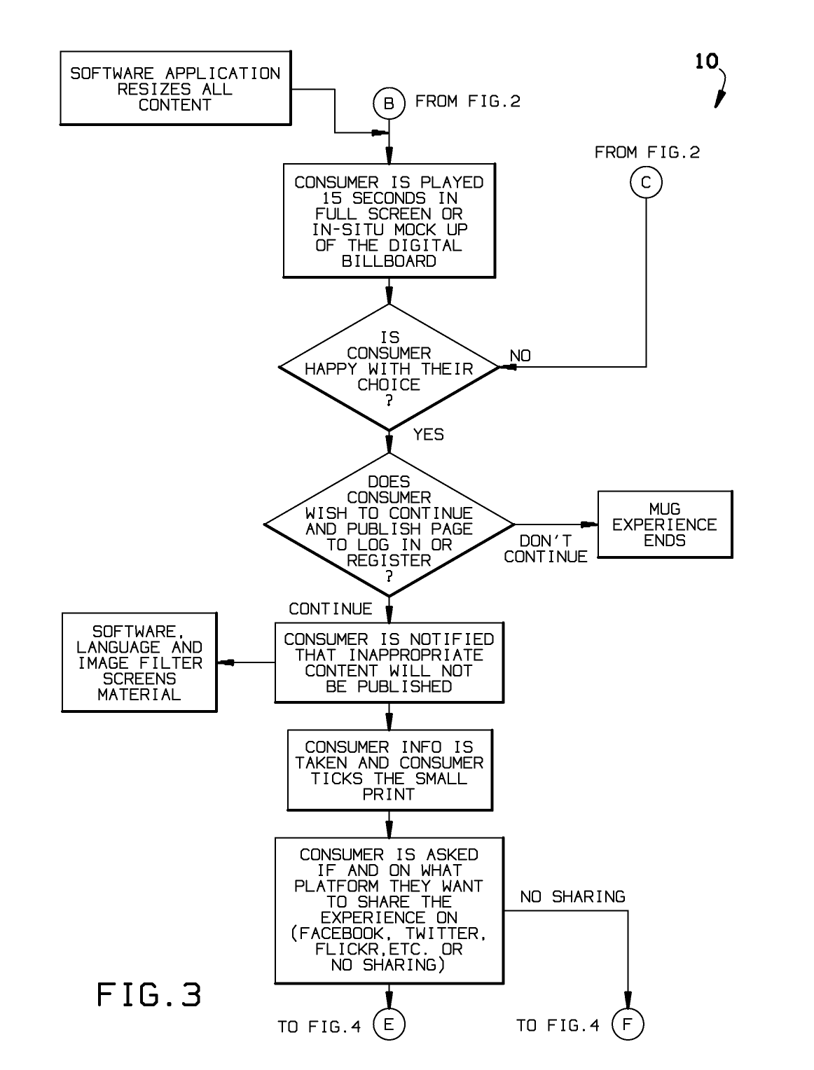

Referring now to FIG. 3, the software may resize all content as appropriate and the software may present the 15 second media display to the consumer for review. This review may show, for example, a mock-up of the digital billboard. If the consumer desires changes, they may do so, else, if the consumer is happy with the presentation, the consumer may be asked to review legal information, including the requirements for appropriate content. The software may contain filters to detect inappropriate language or other inappropriate content. The software may publish after internal screening, or may require an additional (human) screen of the advertisement prior to publication. The consumer may then be asked if they wish the content to be shared on any particular platform (such as Facebook, Twitter, Flickr, or the like).

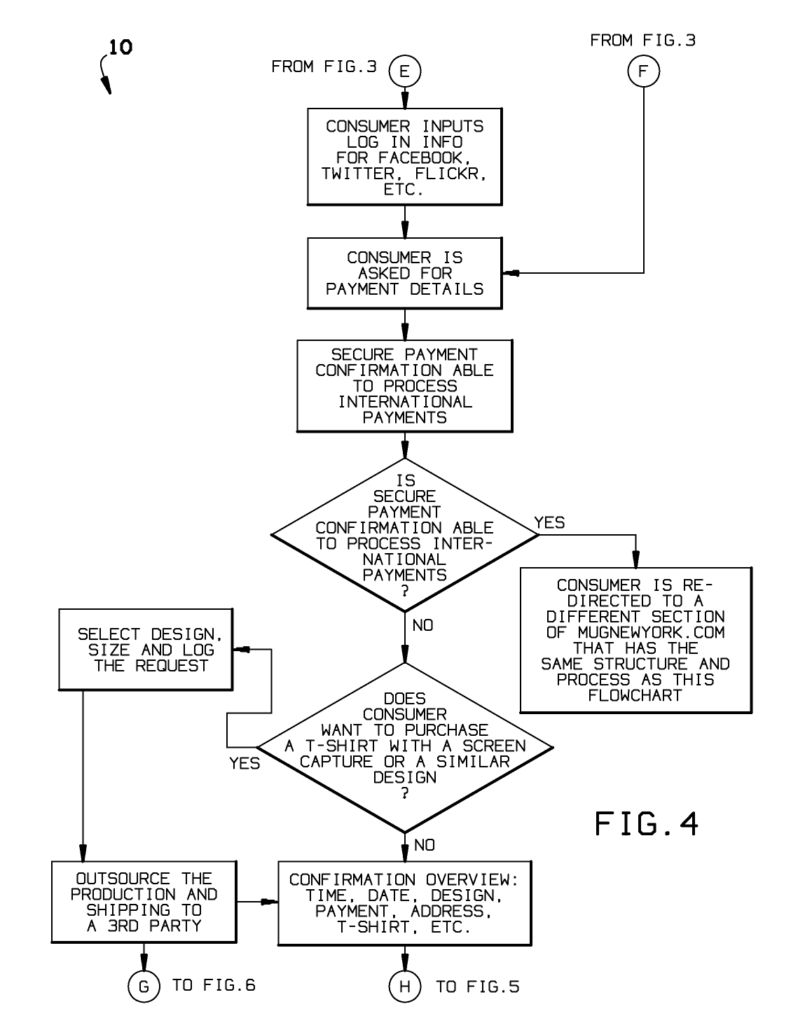

Referring to FIG. 4, if the consumer desires sharing, they may be asked to provide their log-in information to the particular platform(s). The consumer may then be asked for payment details. Other subsystems, as are known in the art, may be provided to accept secure payments over the internet, including international payments. The consumer may be asked if they desire other products (such as a t-shirt, mug, mouse pad, or the like) having an image of their published design. If so, the order is taken and processed either internally or to a third party. The consumer then receives a confirmation of their media publication, including information such as the time, date, design, payment, billboard location, and the like.

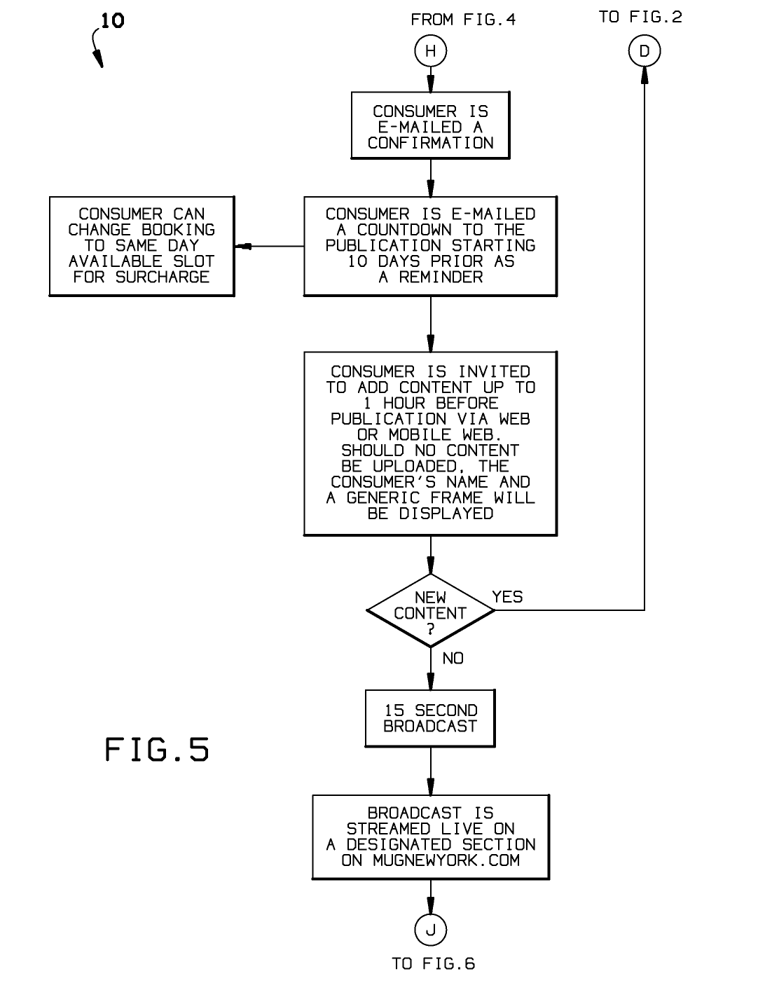

Referring to FIG. 5, the consumer may be sent an email confirmation with the details of the publication. The consumer may be sent email countdowns prior to publication. For example, each day for 10 days prior to the publication, an email may be sent to the consumer. The consumer may be allowed to change the booking to a different time slot, with or without an additional charge. As discussed above, the consumer may be allowed to change the content up to one hour prior to publication. If no media is selected at the time of publication, the name or handle of the consumer may be displayed in a default template. The broadcast may occur on the billboard at the selected time. The broadcast may also appear simultaneously on a predetermined billboard streaming website.

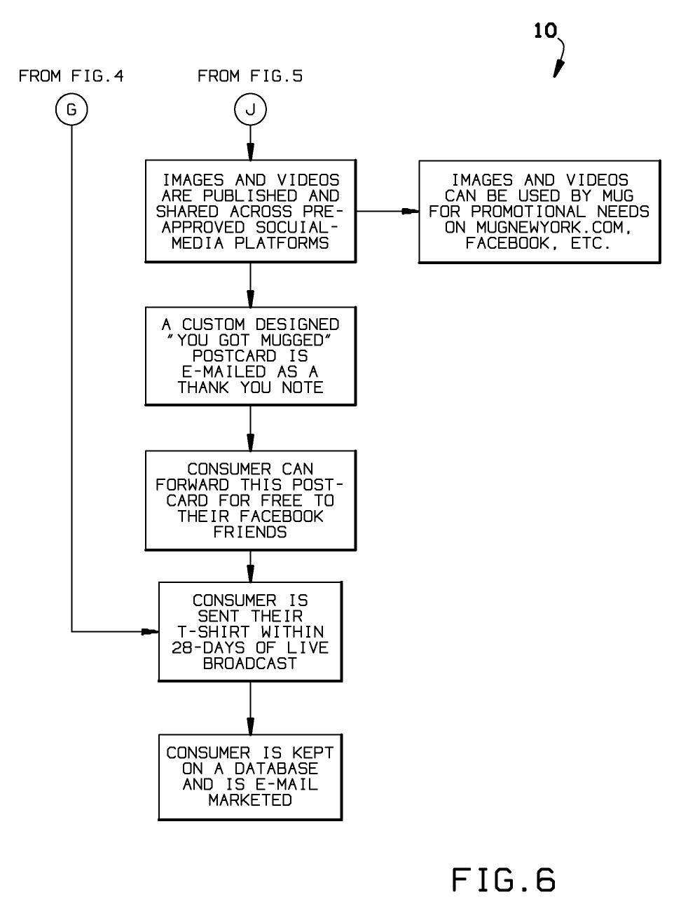

Referring to FIG. 6, the media from the billboard display may be shared across various media platforms, including various social media platforms. A thank you note may be generated and emailed to the user and the user. The thank you note may be an e-postcard showing an image of the consumer's media presentation. The consumer may be given an opportunity to send the postcard to other users or post the postcard on various media platforms. The consumer information may be kept in a database, in accordance with the terms of service of the site, for future promotional purposed.

It should be understood, of course, that the foregoing relates to exemplary embodiments of the invention and that modifications may be made without departing from the spirit and scope of the invention as set forth in the following claims.

What is claimed is:

1. A computer-readable medium containing programmable code for implementing a system for displaying media on a digital billboard, comprising:
a code sequence adapted to receive media from a user;
a code sequence adapted to create a media presentation to fit on a billboard for a predetermined time interval;
a code sequence adapted to receive a selected date and time for displaying the media presentation on the billboard;
a code sequence adapted to transmit the media presentation to the billboard at the selected time and date; and
a code sequence adapted to transmit the media presentation to other media platforms as selected by the user.

2. The computer-readable medium containing programmable code for implementing a system for displaying media on a digital billboard according to claim 1, further comprising a code sequence for providing the user a plurality of design templates for creating the media presentation.

3. The computer-readable medium containing programmable code for implementing a system for displaying media on a digital billboard according to claim 1, further comprising a code sequence for accepting changes to the media presentation up to a predetermined time interval prior to the selected time and date.

4. The computer-readable medium containing programmable code for implementing a system for displaying media on a digital billboard according to claim 1, further comprising a code sequence for screening the media presentation for inappropriate content.

5. A method for displaying a media presentation on a billboard, the method comprising:
receiving media from a user;
creating the media presentation to fit on the billboard for a predetermined time interval;
receiving a selected date and time for displaying the media presentation on the billboard;
transmitting the media presentation to the billboard at the selected time and date; and
transmitting the media presentation to other media platforms as selected by the user.

6. The method of claim 5, wherein the media includes text, photos, video, or combinations thereof.

7. The method of claim 5, wherein the predetermined time interval is 15 seconds.

8. The method of claim 5, further comprising displaying the media presentation to the user for review prior to transmitting the media presentation to the billboard.

9. The method of claim 5, further comprising offering the user to print a still image of their media presentation on personalized merchandise.

10. The method of claim 5, further comprising inviting the user to change the media presentation up to a predetermined time interval prior to the media presentation being displayed on the billboard.
